(19) United States
(12) Patent Application Publication
(10) Pub. No.: US 2001/0045124 A1
(43) Pub. Date: Nov. 29, 2001

(54) Pedal depressor

(76) Inventors: Glen Mouck, Hamilton (CA); Sean Soper, Hamilton (CA)

Correspondence Address: MARK A. KOCH, 866 Main Street East, Hamilton, ON, L8M 1L9, CA

(21) Appl. No.: 09/801,791

(22) Filed: Mar. 9, 2001

Related U.S. Application Data
(60) Provisional application No. 60/193,575, filed on Mar. 30, 2000.

(51) Int. Cl. G01L 3/26

(52) U.S. Cl. 73/132

(57) ABSTRACT

The present invention a pedal depressor is for use in a vehicle having a steering wheel and control pedals. The pedal depressor includes an apparatus for applying downward actuating forces to at least one of said vehicle control pedals, using said steering wheel as a counterforce to said downward actuating force. The pedal depressor further includes a longitudinal rail plate, at one end of said rail, for bearing and applying force against said vehicle control pedal; and a car adapted to slidably move along said rail, said car cooperating with and connected to a device for adjusting said counterforce against said steering wheel, thereby adjusting said force against said control pedal and maintaining said control pedal at a preselected position.

### FIELD OF THE INVENTION

The present invention relates to devices used for depressing control pedals in a vehicle, and more particularly, to pedal depressor used for commercial and non commercial vehicles.

### BACKGROUND OF THE INVENTION

In some jurisdictions there are laws in place which require drivers of commercial vehicles, such as trucks, buses and school buses to carry out periodic inspection of their vehicles brake lights, pneumatic braking systems, and in particularly, the pneumatic brake cylinder travel. In order to carry out these type of inspections, traditionally, one person positioned in the cab of the vehicle would depress the brake pedal or any other control pedal necessary, and a second person outside of the vehicle would walk around the vehicle to carry out the various brake light and other brake inspections required by whatever applicable law.

The present device contemplates eliminating the person in the cab to depress the control pedals, therefore, eliminating one person from the inspection process. In other words, the driver without further help could carry out his own brake light and brake and/or other inspection without a second person.

### THE PRIOR ART

A number of devices which are currently patented have attempted to provide a solution to similar problems. These patents are as follows:

1. U.S. Pat. No. 3,722,266 Titled: BREAK BLEEDING TOOL by John C. Dunham, Filed Jan. 3, 1972 and Issued Mar. 27, 1973 described a spring loaded bar assembly for temporarily holding down an automatic brake pedal.

2. U.S. Pat. No. 5,345,796 Titled: VEHICLE BRAKE PEDAL LOCKING DEVICE by Peter Chieh et al., Filed Mar. 8, 1993 and Issued Sep. 13, 1993 describes a JO device which spans between the brake pedal and the seat of a vehicle in order to lock the brake pedal in the down position. The device is directed towards preventing vehicle theft by keeping the brake system on.

3. U.S. Pat. No. 5,181,404 Titled: MOTOR VEHICLE BRAKE PEDAL LOCKING DEVICE by Franklin Baker, Filed: Sep. 30, 1991 and Issued Jan. 26, 1993 again describes a brake pedal locking device which spans between the vehicle floor pan and a brake pedal. Again the device is directed at preventing theft of a vehicle by locking the brake in the down position.

4. U.S. Pat. No. 4,699,238 Titled: STEERING WHEEL LOCKING DEVICE FOR ROAD VEHICLES by Mosheh Tamir, Filed: Nov. 18, 1986 and Issued Oct. 13, 1997 describes a device which spans between the steering wheel and the brake pedals is directed towards a device which prevents moving the steering wheel or locking the steering wheel in a lock position, and at the same time preventing depression of the brake pedals. Again this device is directed towards preventing theft of the vehicle by disabling the steering wheel and the brakes with one apparatus.

Unlike the above mentioned patents, the present invention is directed towards a device which will enable the driver of the vehicle to depress a brake and/or any other control pedal temporarily for the purpose of inspecting various components of a vehicle such as brake and pneumatic lines and/or carrying out repair work. The device is designed to be mounted and dismounted quickly and efficiently, and to provide for a positive depression and/or position placement of control pedals including but not limited to the clutch, brake and gas pedal of a vehicle.

### SUMMARY OF THE INVENTION

The present invention a pedal depressor for use in a vehicle having a steering wheel and control pedals, said pedal depressor comprises:

a) a means for applying downward actuating forces to at least one of said vehicle control pedals, using said steering wheel as a counterforce to said downward actuating force.

Preferably said applying means comprises:

a) a longitudinal rail;

b) a plate means, at one end of said rail, for bearing and applying force against said vehicle control pedal; and

c) a means, moveable along said rail, for contacting and applying a counterforce against said steering wheel.

Preferably said moveable contacting means includes:

a) a means for adjusting said counterforce against said steering wheel, thereby adjusting said force against said control pedal and maintaining said control pedal at a preselected position.

Preferably said adjusting means comprises:

I) a threaded shaft threadably received through a threaded aperture defined in said moveable contacting means;

ii) said shaft having a means at a first end for engaging with said steering wheel; and

iii) said shaft including a means at a second end for manually turning said shaft for urging said engaging means against said steering wheel for providing a counterforce to the force applied to said control pedal.

Preferably said engaging means includes a yoke pivotally attached with a ball and socket joint to said first end of said shaft for making contact with and engaging said steering wheel.

Preferably said moveable contacting means includes:

a) a car adapted to slidably move along said rail, said car cooperating with and connected to said adjusting means, for bringing said adjusting means into contact with said steering wheel.

Preferably said moveable contacting means further includes:

a) an arm with a first end rigidly attached to and extending from said car; and the second end connected to and co-operating with said adjusting means.

Preferably said moveable contacting means further includes a lug integrally connected to said arm at said second end for connecting with said adjusting means.

Preferably said lug includes a threaded lug aperture defined within said lug for threadably receiving said threaded shaft there through.

Preferably said rail including transverse grooves on a bottom side and top side of said rail; and said car including transverse ridges cooperating and meshing with said grooves when an off centre force is applied to said car thereby locking said car in a preselected position.

Preferably said plate means includes a base plate pivotally connected to one end of said rail for making contact with said control pedal.

Preferably said plate means further includes a bracket integrally connected to said base plate and pivotally connected to one end of said rail with a pin.

Preferably said plate means further includes a lip integrally part of said base plate which is adapted to extend around and contact the under side of said control pedal for preventing accidental disengagement of said base plate from said control pedal.

### BRIEF DESCRIPTION OF THE DRAWINGS

The invention will now be described by way of example only with references to the following drawings in which:

FIG. 1 is a schematic perspective representation of the present invention, a pedal depressor.

FIG. 2 is a top plan view of the present invention, a pedal depressor

FIG. 3 is a side plan view of the pedal depressor shown in FIG. 2.

FIG. 4 is a side plan view of the present invention; a pedal depressor, shown deployed in a schematic representation of a portion of a driver's cab of a vehicle having a seat, steering wheel and brake pedal arrangement.

### DETAILED DESCRIPTION OF THE PREFERRED EMBODIMENT

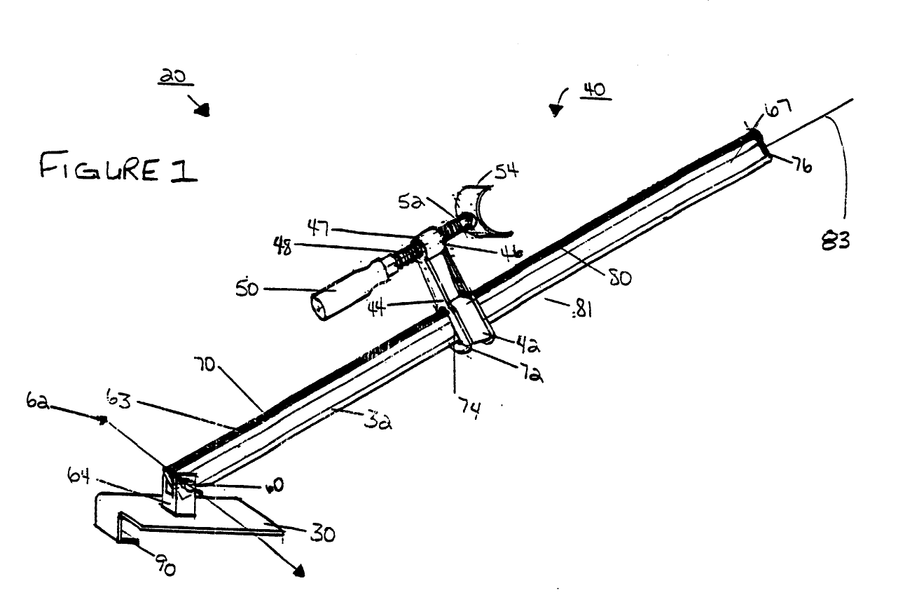

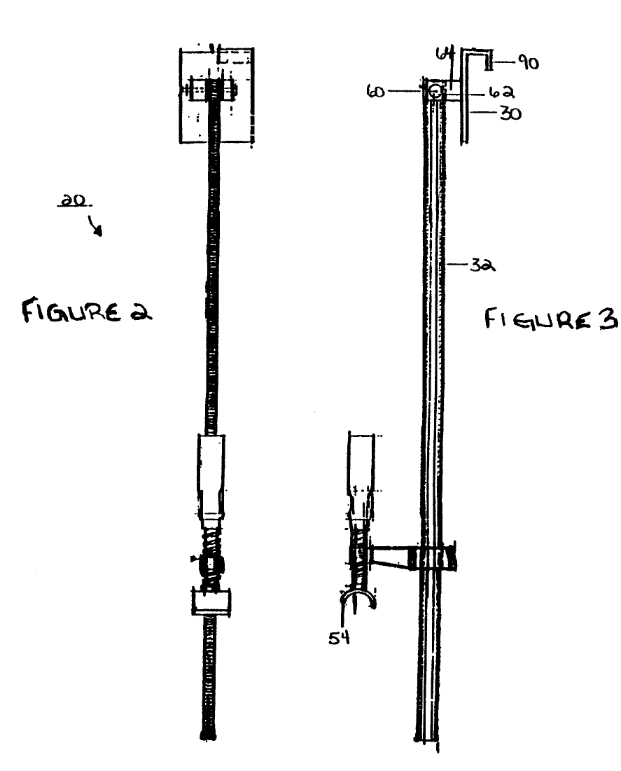

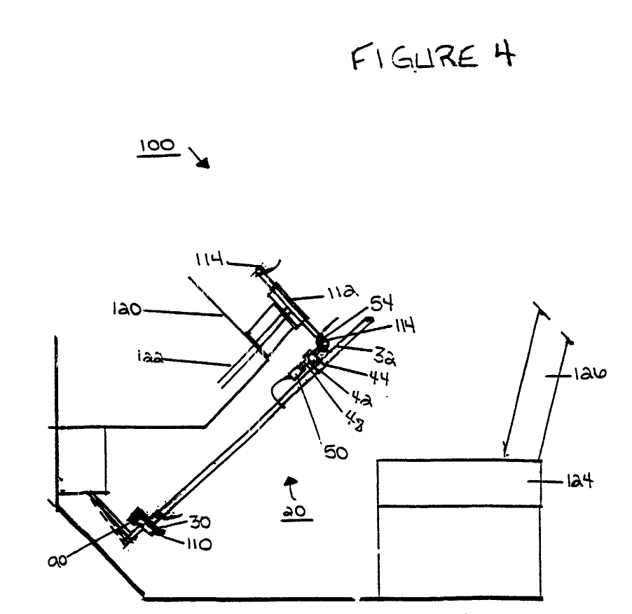

The present invention, a Pedal Depressor, shown generally as 20 in FIG. 1 comprises the following major components, the base plate 30, rail 32 and tightening mechanism 40.

The tightening mechanism 40 includes car 42 having an arm 44 and a lug 46 integrally part of car 42. A handle 50 rigidly connected to threaded shaft 48 passes through threaded lug 46. Threaded shaft 48 has a ball and socket joint 52 at one distill end thereof, which connects yoke 54 with threaded shaft 48.

Base plate 30 preferably includes bracket 64 which is pivotally attached to plate end 63 of rail 32 with a pin 60. Pin 60 is oriented concentrically along pivot axis 62 and connects base plate 30 pivotally to rail 32.

Rail 32 preferably has grooves 70 which run transversally across the top side 80 of rail 32 and the bottom side 81 of rail 32. Grooves 70 preferably run along the entire length of rail 32 and are on both the top side 80 and bottom side 81 of rail 32. Corresponding ridges 72 are found within rail aperture 74 in car 42 and are adapted to mate and co-operate with grooves 70 located on rail 32. Ridges 72 within rail aperture 74 of car 42 engage with grooves 70 in cantilever fashion to lock car 42 in a given position. Ridges 72 within rail aperture 74 can be provided for example by a set screw (not shown) threaded into car 42 such that a portion of the threads of the set screw are exposed within rail aperture 74 for cooperating and engaging with grooves 70 on rail 32. The exposed threads of the set screw provide the necessary ridges 72 for engaging with grooves 70. In this manner when the threads (ridges 72) on the set screw become worn they can be simply replaced by inserting another set screw into car 42. It will be apparent to persons skilled in the art that other systems other than using grooves and ridges can be used on rail 32 and rail apertures 74 in order to lock car 42 along the length of rail 32 at any selective position. For example car 42 may be prevented from moving along rail 32 by applying an offset force (offset from longitudinal axis 83) to car 42 thereby creating frictional resistance when car 42 impinges upon rail 32 in a skewed manner due to the offset forces. Additionally locking screws, pins, or clamping mechanisms can be provided to lock car 42 in a desired position along rail 32.

In addition, rail 32 has a stop 76 at stop end 67 to prevent car 42 from completely coming off rail 32.

In use, as best viewed in FIG. 4, pedal depressor 20 is shown inside cross sectional view deployed in driver's cab 100, wherein pedal depressor 20 is mounted between brake pedal 110 and steering wheel 120 of the vehicle. Drivers cab 100 may be the cab of a truck, bus, car or other vehicle having control pedals and a steering wheel.

A typical vehicle will have a seat 124, seat back 126, a steering column 122 having mounted thereon a steering wheel 112, which has a steering wheel rim 114. Normally, steering column 122 emerges from dash 120 and underneath dash 120 is located control pedals including clutch pedal, gas pedal, brake pedal, emergency brake pedals, and other pedals necessary to control the vehicle. For simplicity, in FIG. 4 only shows a brake pedal 110 and pedal depressor 20 deployed between break pedal 110 and steering wheel rim 114.

When a driver or mechanic would like to depress any control pedal including break pedal 110 for inspection of brake lights, for inspection of porous or leaking break lines, for inspection of brake wear, for inspection of brake travel throw, for inspection of clutch pedal free play or clutch plate clearance, for inspection of diesel injection pump throttle positions, for inspection of hydraulic and pneumatic break components and/or for any other reason, pedal depressor 20 can be installed to span between a control pedal or, as in this example, brake pedal 110 and steering wheel 112 as shown in FIG. 4.

In order to install pedal depressor 20, base plate 30 is placed over brake pedal 110 and lip 90 of base plate 30 wraps around and engages the back of brake pedal 110 in order to prevent accidental disengagement and/or catapulting of pedal depressor 20 from brake pedal 110 when the pressure is released from brake pedal 110.

To install pedal depressor 20, first of all, base plate 30 is placed onto brake pedal 110 in such a position that lip 90 is mounted over top and makes contact with the back of brake pedal 110.

Subsequently, car 42 is urged along rail 32 until yoke 54 makes contact with steering wheel rim 114 as shown in FIG. 4. The ball and socket joint 52 will accommodate any angular relationship between brake pedal 110 and steering wheel rim 114. Once yoke 54 is in place and making contact with steering wheel rim 114, handle 50 is rotated preferably clockwise, thereby rotating threaded shaft 48, which in turn urges yoke 54 against steering wheel rim 14, thereby applying counter force against steering wheel rim 114 and force against brake pedal 110. When counter force is applied to yoke 54, the force transmitted through lug 46, arm 44 and to car 42 results in locking car 42 along rail 32 in a locked position by engaging grooves 70 with ridges 72 within rail apertures 74. A force applied to car 42 which is off centre from longitudinal axis 83 results in ridges 72 co-operating and meshing with grooves 70, thereby looking car 42 in a pre-selected position.

By continuing to rotate handle 50 increased counter force is applied to steering wheel rim 114, and therefore, increased force is applied to brake pedal 110. The user, therefore, can continue to rotate handle 50 until the brake pedal 110 is depressed to the desirable location. Brake pedal 110 can be partially or completely depressed as desired. When enough force has been applied by rotating handle 50, pedal depressor 20 can be left in position wherein base plate 30 is applying force against brake pedal 110, and a counterforce is being applied against steering wheel rim 114 via yoke 54.

Once pedal depressor 20 is in place then the necessary inspections and/or repair work can be done on the various systems on the vehicle including brake light inspections, hydraulic brake leak inspections, brake travel inspections, air brake leak inspections, gas pedal travel inspections, clutch travel inspections, clutch free-play inspections and other inspections can also be carried out by using pedal depressor 20.

In order to disengage pedal depressor 20, handle 50 is rotated in a counter clockwise direction in order to release the counter force being applied by yoke 54 against steering wheel rim 114, and the force of base plate 30 against brake pedal 110. As the force is released, brake pedal 110 will move back to its home position. To ensure that there are no sudden releases of pressure and to ensure that rail 32 does not unexpectedly disengage from brake pedal 110 in an uncontrollable manner, lip 90 prevents pedal depressor 20 from disengaging from brake pedal 110 without using manual intervention.

It will be noted that FIG. 4 depicts a brake pedal 110 as an example of how pedal depressor 20 can be installed. Pedal depressor 20 can also be installed onto an accelerator pedal or a clutch pedal or any other control pedal.

It is also evident that many different configurations of base plate 30 are possible to accommodate different thickness and dimensions of various control pedals.

It should be apparent to persons skilled in the arts that various modifications and adaptations of this structure described above are possible without departure from the spirit of the invention the scope of which defined in the appended claims.

I claim:

1. A pedal depressor for use in a vehicle having a steering wheel and control pedals, said pedal depressor comprising:
a) a means for applying downward actuating forces to at least one of said vehicle control pedals, using said steering wheel as a counterforce to said downward actuating force.

2. The pedal depressor claimed in claim 1, wherein said applying means comprises:
a) a longitudinal rail;
b) a plate means, at one end of said rail, for bearing and applying force against said vehicle control pedal; and
c) a means, moveable along said rail, for contacting and applying a counterforce against said steering wheel.

3. The pedal depressor claimed in claim 2, wherein said moveable contacting means includes:
a) a means for adjusting said counterforce against said steering wheel, thereby adjusting said force against said control pedal and maintaining said control pedal at a preselected position.

4. The pedal depressor claimed in claim 3, wherein said adjusting means comprises:
I) a threaded shaft threadably received through a threaded aperture defined in said moveable contacting means;
ii) said shaft having a means at a first end for engaging with said steering wheel; and
iii) said shaft including a means at a second end for manually turning said shaft for urging said engaging means against said steering wheel for providing a counterforce to the force applied to said control pedal.

5. The pedal depressor claimed in claim 8, wherein said engaging means includes a yoke pivotally attached with a ball and socket joint to said first end of said shaft for making contact with and engaging said steering wheel.

6. The pedal depressor claimed in claim 4, wherein said moveable contacting means includes:
a) a car adapted to slidably move along said rail, said car cooperating with and connected to said adjusting means, for bringing said adjusting means into contact with said steering wheel.

7. The pedal depressor claimed in claim 4, wherein said moveable contacting means further includes:
a) an arm with a first end rigidly attached to and extending from said car; and the second end connected to and co-operating with said adjusting means.

8. The pedal depressor claimed in claim 5, wherein said moveable contacting means further includes a lug integrally connected to said arm at said second end for connecting with said adjusting means.

9. The pedal depressor claimed in claim 6, wherein said lug includes a threaded lug aperture defined within said lug for threadably receiving said threaded shaft there through.

10. The pedal depressor claimed in claim 9, wherein:
a) said rail including transverse grooves on a bottom side and top side of said rail;
b) and car including transverse ridges cooperating and meshing with said grooves when an off centre force is applied to said car thereby locking said car in a preselected position.

11. The pedal depressor claimed in claim 10, wherein said plate means includes a base plate pivotally connected to one end of said rail for making contact with said control pedal.

12. The pedal depressor claimed in claim 11, wherein said plate means further includes a bracket integrally connected to said base plate and pivotally connected to one end of said rail with a pin.

13. The pedal depressor claimed in claim 12, wherein said plate means further includes a lip integrally part of said base plate which is adapted to extend around and contact the under side of said control pedal for preventing accidental disengagement of said base plate from said control pedal.

14. A pedal depressor for use in a vehicle having a steering wheel and control pedals, said pedal depressor comprising:
a) a longitudinal rail including transverse grooves on a bottom side and top side of said rail;
b) a means moveable along said rail for contacting and applying force against said steering wheel, wherein said moveable means comprises:
I) a car adapted to slidably move along said rail and including transverse ridges cooperating and meshing with said grooves such that applying an off centre force to said car thereby locking said car in a preselected position;
ii) an arm at one end extending from and rigidly attached to said car; and at the other end a lug including a threaded aperture defined therein;
iii) a threaded shaft threadably received through said threaded aperture, said shaft including a handle at one end for manually turning said shaft and at the other end a yoke pivotally attached with a ball and socket joint to said shaft, said yoke for making contact with said steering wheel wherein turning said handle urges said yoke toward or away from said steering wheel;
c) a plate means at one end of said rail for bearing and applying force against said control pedal, wherein said plate means comprises:
I) a base plate including an integrally connected bracket which is pivotally connected to one end of said rail with a pin;
ii) wherein said base plate further including a lip integrally part of said base plate which is adapted to extend around and contact the under side of said control pedal for preventing accidental disengagement of said base plate from said control pedal.
